(19) United States
(12) Patent Application Publication
(10) Pub. No.: US 2023/0326061 A1
(43) Pub. Date: Oct. 12, 2023

(54) A Cargo Tracking System for Tracking a Cargo, as Well as a Corresponding Method

(71) Applicant: DAIMLER AG, Stuttgart (DE)

(72) Inventors: Naveen SANGENENI, Fremont, CA (US); Andrew KANESHIRO, Los Altos, CA (US); Nikhil KULKARNI, San Jose, CA (US)

(21) Appl. No.: 18/041,937

(22) PCT Filed: Jun. 25, 2021
(86) PCT No.: PCT/EP2021/067474

§ 371 Date: Feb. 16, 2023

(30) Foreign Application Priority Data
Aug. 20, 2020 (GB) 2012982.1

(51) Int. Cl. G06T 7/62; G06Q 10/0833; G06T 7/20; G06T 7/50; G06V 20/62

(52) U.S. Cl. CPC G06T 7/62; G06Q 10/0833; G06T 7/20; G06T 7/50; G06V 20/63; G06T 2207/10012; G06T 2207/20084

(57) ABSTRACT

A cargo tracking system for tracking a cargo includes a camera and a central electronic computing device. The cargo, during a loading of the cargo into a cargo space for delivering the cargo, is trackable by the camera. An information about the cargo is transmittable by the camera to the central electronic computing device. The camera is configured to estimate a size of the cargo in real time and, depending on the estimated size of the cargo and depending on a predetermined cargo size of the cargo space, the camera is configured to compute a remaining cargo size of the cargo space and to transmit the computed remaining cargo size to the central electronic computing device in real time.

### BACKGROUND AND SUMMARY OF THE INVENTION

The invention relates to the field of automobiles. More specifically, the invention relates to a cargo tracking system for tracking a cargo as well as a corresponding method.

Particularly, parcel delivery companies need to have efficient systems for tracking the location of their customer's packages during the delivery process. In addition, these businesses need data accessible to them regarding to the loading of parcels into their package containers to be used, for example, for assigning vehicles to particular routes, deciding which parcels should be placed in particular containers, and planning and mapping vehicle routes. This data may consist of numbers of parcels on a conveyor, the shape and volume of parcels, the direction of travel of parcels on a conveyor, and the flow rate of parcels being loaded into a container.

U.S. Pat. No. 7,180,050 B2 discloses an object detection device that includes an imaging section for taking an image, a tag communication section for receiving tag information transmitted from an information tag attached to a given target, and a target detection section for detecting the given target in the image taken by the imaging section using the tag information received by the tag information section.

U.S. Pat. No. 6,992,587 B2 discloses an apparatus and a method for managing articles. Articles are managed using an image capturing device that captures articles to which radio tags having different identifications are attached, and the tag identifications of the radio tags of the articles are received using the tag identification reception card. A captured image is associated with a received tag identification and entered. A plurality of articles are managed in a group using captured images and received tag identifications.

The prior art teaches detecting and tracking parcels based on tagging, identification and labeling methods, and taking and storing images with other parcel information associated with the particular identification numbers, labels or tags. Although these systems provide opportunities for parcel delivery companies to identify and track their parcels, these systems do not provide methods for collecting information that could be used by parcel delivery companies for making predictions around parcel loading, route planning and delivery resource allocation. The present invention addresses this need in the art through a cargo tracking system as well as to a corresponding method.

It is an object of the invention to provide a cargo tracking system as well as a corresponding method, by which more detailed information of the cargo may be computed for a user of the cargo tracking system.

One aspect of the invention relates to a cargo tracking system for tracking a cargo, with at least one camera and one central electronic computing device, wherein the camera tracks the cargo during loading of the cargo in a cargo space for delivering the cargo and the camera transmits information about the cargo to the central electronic computing device.

It is envisaged that the camera is configured to estimate a size of the cargo in real time and depending on the estimated size of the cargo and depending on a predetermined cargo size of the cargo space, the camera is configured to compute a remaining cargo size of the cargo space and to transmit the computed remaining cargo size to the central electronic computing device in real-time.

Therefore, detailed information about the cargo, in particular about the cargo in the cargo space, is provided by the cargo tracking system. Therefore, a user of the cargo tracking system gets more information about the cargo in the cargo space in real time. In particular, the cargo may be a parcel and the cargo tracking system may be a parcel tracking system.

In other words, the present invention relates to the cargo tracking and detection system. The cargo tracking system comprises at least one camera that is able to capture images of the cargo, an algorithm for taking captured images and identifying the cargo size, in particular the cargo volume, location, direction of travel and cargo loading volume, and storing this information in the central electronic computing device, which may be a cloud server, so that it is accessible in the form of an interface to a user of the cargo tracking system.

Once the total size of the cargo space is known and the size of each cargo going in is known, it is possible to compute how much volume is left in the cargo space and when a new cargo space needs to be sent to a customer loading dock and which of the loading docks. All this information is stored in the central electronic computing device. A user of the cargo tracking system gets access in real time to the information of how cargos are being seen by the camera and the direction in which they are travelling. For any given moment in time, an average may be taken from what was seen during the same period from the time the conveyor belt and location went live.

According to an embodiment, the camera is arranged at the cargo space and the size of the cargo is estimated by using a focal length of the camera and a detected distance of the cargo to the camera. Alternatively, the camera may be a scanner. The camera is located, in particular in the front of the cargo space, wherein the cargo space may be a motor vehicle or a cargo container. The volume of each cargo is calculated in real time and updated to the central electronic computing device. The ratio of the size of the cargo on the camera and the size of the cargo in real life is the same as the ratio between the focal length and the distance of the object:

ObjectSize_OnSensor/Object_RealSize=Focal_Length/Distance

The “ObjectSize_OnSensor” is the cargo size as detected by the sensor in the camera. “Object_RealSize” is the known cargo size based on data obtained from memory or the central electronic computing device. Data may be known based on the shipping label on the cargo or size of the cargo package.

In a further embodiment, for estimating the size of the cargo a height of the cargo is detected by the camera and a size of at least one edge of the cargo is detected by the camera. The height of the top of the cargo from the camera may be computed with the formula:

Height=(Focal_Length*Object_RealSize)/ObjectSize_OnSensor

Knowing the height of the top of the cargo, there may be a similar operation to find a distance of a conveyor belt from the camera. Therefrom the height of the cargo may be computed. The camera may look for edges of the cargo. Either, the edges may be detected by training a neural network of the camera to look for boxes along with barcodes or using computer vision technology to look for edges of a boundary from the barcode boundaries. To detect the size of the edges of the cargo as seen on the camera, the height of the cargo is used. By the Formula:

Object_Edge_RealSize=(Height*Object_EdgeSize_OnSensor)/Focal_Length

the size of an edge of the cargo may be computed. The size of the cargo, which may be in particular the volume of the cargo, is computed with the height of the cargo, the length of the cargo and the width of the cargo. Most of the time, the cargo may be seen just partially. The serial number and the bounding box is computed around the region of interest of the barcode.

In another embodiment, the camera is configured as a stereo camera facing a door of the cargo space and the camera estimates the size of the cargo depending on a predetermined height of the cargo space and a detected height of the cargo. In particular, a size detection is realized with the stereo camera. The camera is facing the door and looks for the cargo entering from the door. The camera faces for the cargo when exactly the cargo is at the door of the van. By using the distance from the camera within a threshold range, a height of the floor of the cargo space with the roof of the cargo space is known and is constant. The number of pixels corresponding to the actual height of the cargo space is predetermined. When the cargo is entering the door, the number of pixels in height, which is occupied by the cargo, is computed. The current height of the cargo is computed in relation to the number of pixels occupied by the height of the cargo space. A rough estimation of the size may be done by assuming that the height is the same as the length and the width, assuming the cargo is occupied for an accurate volume estimation.

In a further embodiment, the cargo tracking system comprises a conveyor belt for delivering the cargo to the cargo space, wherein a distance of the conveyor belt to the camera is taken into consideration by estimating the size of the cargo. Therefore an accurate computing of the size of the cargo may be realized.

In another embodiment, a characterizing parameter of the cargo is detected by the camera, and the characterizing parameter is taken into consideration by estimating the size of the cargo. Therefore, the size may be computed with a mono-color camera. Therefore, the assumption is done that the cargo, which is entering the cargo space, is not a soft package. At least five frames from the same cargo have to be seen from the camera before the cargo enters the cargo space.

In another embodiment, the characterizing parameter is a tracking number of the cargo and/or a barcode on the cargo and/or a writing on the cargo describing the size of the cargo. Therefore, in order to determine the size of the cargo, a recognition of the characterizing parameter is realized. If the cargo has, for example, a fixed volume, this volume may be used as an information to estimate the cargo. Other characters, for example, a writing like “small box”, “large box” or furthermore may be taken into consideration. Furthermore, a color of the cargo may be given a hint to the size of the cargo. In order to compute the size of the cargo, two sides of the cargo may be detected. Once the length of the two sides of the cargo are known, the volume can be computed. For other cargos, the camera is configured to determine how many sides were seen in all the frames and the cargo was being loaded into the cargo space. If there were frames, when the cargo was slanted, the camera may determine the angle at which the characterizing parameter was. Therefore, a determining of the angle of the cargo may be done. The third side of the cargo may be estimated on the best frame that was visible.

In another embodiment, a speed of a conveyor belt is taken into consideration by the cargo tracking system and depending on the speed a point in time is predetermined, when the cargo space is reaching its loading capacity. The conveyor belt speed is required to determine the rate at which the cargo comes down the conveyor belt. The conveyor belt speed may be measured by determining the change of location of the cargo between frames. The speed calculation may be used supplemental to volume detection to estimate when the container will reach loading capacity.

In another embodiment, at least the camera comprises a neural network for estimating the size of the cargo. Therefore, an advantageous form for the camera is presented.

Another aspect of the invention relates to a method for tracking a cargo by a cargo tracking system, wherein a camera of the cargo tracking system tracks the cargo during a loading of the cargo in a cargo space for delivering the cargo and the camera transmits an information about the cargo to a central electronic computing device of the cargo tracking system.

It is envisaged that a size of the cargo is estimated by the camera in real-time and depending on the estimated size of the cargo and depending on a predetermined cargo size of the cargo space, a remaining cargo size of the cargo space is computed by the camera and the remaining cargo size is transmitted to the central electronic computing device in real time.

Advantageous forms of the cargo tracking system may be regarded as advantageous forms of the method. The cargo tracking system comprises means for performing the method.

Further advantages, features, and details of the invention derive from the following description of preferred embodiments as well as from the drawings. The features and feature combinations previously mentioned in the description as well as the features and feature combinations mentioned in the following description of the figures and/or shown in the figures alone can be employed not only in the respectively indicated combination but also in any other combination or taken alone without leaving the scope of the invention.

The drawings, which are incorporated in and constitute part of this disclosure, illustrate exemplary embodiments and together with the description, serve to explain the disclosed principles. In the figures, the same reference signs are used throughout the figures to refer to identical features and components. Some embodiments of the system and/or methods in accordance with embodiments of the present subject-matter are now described below, by way of example only, and with reference to the accompanying figures.

### BRIEF DESCRIPTION OF THE DRAWINGS

FIG. 1 is a schematic side view of an embodiment of a cargo tracking system; and

FIG. 2 is another schematic side view of another embodiment of the cargo tracking system.

### DETAILED DESCRIPTION OF THE DRAWINGS

In the figures the same elements or elements having the same function are indicated by the same reference signs.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawings and will be described in detail below. It should be understood, however, that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion so that a setup, device or method that comprises a list of components or steps does not include only those components or steps but may include other components or steps not expressly listed or inherent to such setup or device or method. In other words, one or more elements in a system or apparatus preceded by “comprises” or “comprise” does not or do not, without more constraints, preclude the existence of other elements or additional elements in the system or method.

In the following detailed description of the embodiments of the disclosure, reference is made to the accompanying drawings that form part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

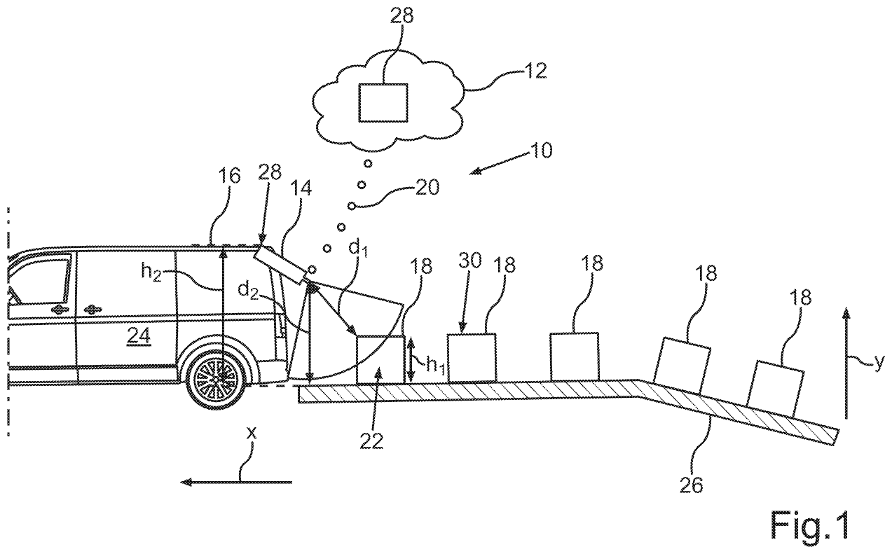

FIG. 1 shows a schematic side view of an embodiment of a cargo tracking system 10. The cargo tracking system 10 comprises at least a central electronic computing device 12, which may be configured as a cloud server. Furthermore, the cargo tracking system 10 may comprise a camera 14. According to this embodiment, the camera 14 is arranged at a cargo space 16, which is shown as a van. The cargo space 16 may also be a cargo container.

In this embodiment, FIG. 1 shows the cargo tracking system 10 for tracking a cargo 18. The camera 14 tracks the cargo 18 during a loading of the cargo 18 into the cargo space 16 for delivering the cargo 18 and the camera 14 transmits an information 20 about the cargo 18 to the central electronic computing device 12. The camera 14 is configured to estimate a size 22 of the cargo 18 in real time and depending on the estimated size 22 of the cargo 18 and depending on a predetermined cargo size 24 of the cargo space 16, the camera 14 is configured to compute a remaining cargo size of the cargo space 16 and to transmit the computed remaining cargo size to the central electronic computing device 12 in real time.

According to the embodiment shown in FIG. 1, the cargo tracking system 10 comprises a conveyor belt 26 for delivering the cargo 18 to the cargo space 16, wherein a distance d2 of the conveyor belt 26 to the camera 14 is taken into consideration by estimating the size 22 of the cargo 18.

According to the embodiment shown in FIG. 1, the camera 14 is arranged at the cargo space 16 and the size 22 of the cargo 18 is estimated by using a focal length of the camera 14 and a detected distance d1 of the cargo 18 to the camera 14. For estimating the size 22 of the cargo 18, a height h1 of the cargo 18 is detected by the camera 14 and a size of at least one edge of the cargo 18 is detected by the camera 14.

According to an alternative form of an embodiment, the camera 14 is configured as a stereo camera facing a door of the cargo space 16 and the camera 14 estimates the size 22 of the cargo 18 depending on a predetermined height h2 of the cargo space 16 and the detected height h1 of the cargo 18.

In an embodiment, a characterizing parameter 30 of the cargo 18 is detected by the camera 14 and the characterizing parameter 30 is taken into consideration by estimating the size 22 of the cargo 18. The characterizing parameter 30 may be a tracking number of the cargo 18 and/or a barcode on the cargo 18 and/or a writing on the cargo 18 describing the size 22 of the cargo 18.

In particular, FIG. 1 shows the cargo tracking system 10 for tracking cargo 18 comprising the camera 14 mounted to the back door of the van that constantly captures images of an area between the conveyor belt 26 and the back door of the van. The cargo tracking system 10 is connected to the central electronic computing device 12 in order to obtain and store information regarding each cargo 18.

Furthermore, the camera 14 and/or the electronic computing device 12 may comprise a neural network 28 for estimating the size 22 of the cargo 18.

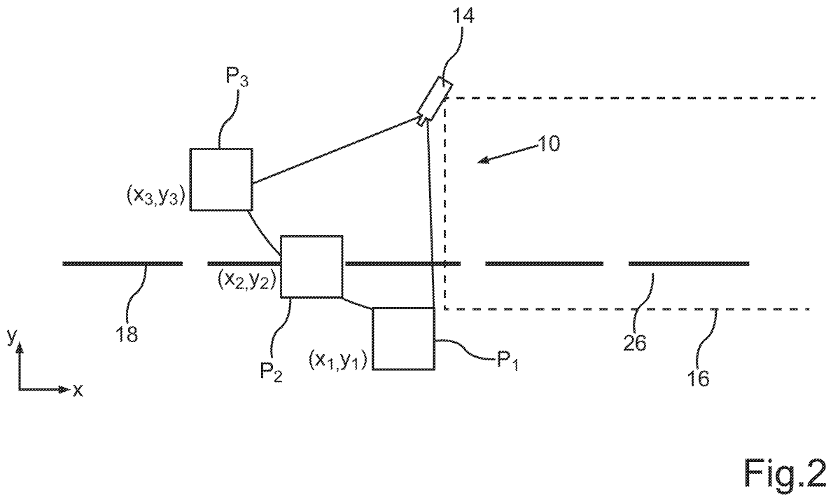

FIG. 2 shows another schematic side view according to an embodiment of the cargo tracking system 10. In particular, FIG. 2 shows the cargo tracking system 10 for a detection of timing of the cargo 18 on the conveyor belt 26 and the direction of travel of the cargo 18. In particular, an x direction and a y direction are shown. The x direction may be a direction along a longitudinal axis of the cargo space 16 and the y direction may be a direction along a vertical axis of the cargo space 16.

FIG. 2 shows three positions P1, P2, P3. A first position P1 may be in a first point in time, a second position P2 may be in a second point in time, and a third position P3 may be in a third point of time. With the embodiment shown in FIG. 2, a direction of travel of the cargo 18 may be computed. The cargo tracking system 10 is configured to parse logs for each unique barcode and obtain the coordinates of the original region of interest for each instance of the barcode from the camera 14. If the last coordinate's value from the y direction is greater than the y value of the coordinate seen in the first frame or in the first position P1 for that cargo 18, the cargo 18 is moving to the cargo space 16. If the last y coordinate is less than the first y coordinate, the cargo 18 is moving away from the cargo space 16. According to an embodiment shown in FIG. 2, the cargo 18 is moving away from the cargo space 16.

Furthermore, the speed of the conveyor belt 26 may be taken into consideration by the cargo tracking system 10 and depending on the speed a point in time is predetermined, when the cargo space 16 reaches its loading capacity.

A further aspect of the invention according to FIG. 1 and FIG. 2 relates to a method for tracking the cargo 18 by the cargo tracking system 10, wherein the camera 14 for the cargo tracking system 10 tracks the cargo 18 during a loading of the cargo 18 into the cargo space 16 for delivering the cargo 18 and the camera 14 transmits the information 20 about the cargo 18 to the central electronic computing device 12. A size of the cargo 18 is estimated by the camera 14 in real time and depending on the estimated size 22 of the cargo 18 and depending on the predetermined cargo size 24 of the cargo space 16 a remaining cargo size of the cargo space 16 is computed by the camera 14 and the remaining cargo size is transmitted to the central electronic computing device 12 in real time.

1.-10. (canceled)

11. A cargo tracking system (10) for tracking a cargo (18), comprising:
a camera (14); and
a central electronic computing device (12);
wherein the cargo (18), during a loading of the cargo (18) into a cargo space (16) for delivering the cargo (18), is trackable by the camera (14) and wherein an information (20) about the cargo (18) is transmittable by the camera (14) to the central electronic computing device (12);
wherein the camera (14) is configured to estimate a size (22) of the cargo (18) in real time and, depending on the estimated size (22) of the cargo (18) and depending on a predetermined cargo size (24) of the cargo space (16), the camera (14) is configured to compute a remaining cargo size of the cargo space (16) and to transmit the computed remaining cargo size to the central electronic computing device (12) in real time.

12. The cargo tracking system (10) according to claim 11, wherein the camera (14) is disposed at the cargo space (16) and the size (22) of the cargo (18) is estimated by using a focal length of the camera (14) and a detected distance (d1) of the cargo (18) to the camera (14).

13. The cargo tracking system (10) according to claim 11, wherein a height (h1) of the cargo (18) is detectable by the camera (14) and a size of at least one edge of the cargo (18) is detectable by the camera (14) for estimating the size (22) of the cargo (18).

14. The cargo tracking system (10) according to claim 11, wherein the camera (14) is configured as a stereo camera facing a door of the cargo space (16) and the camera (14) estimates the size (22) of the cargo (18) depending on a predetermined height (h2) of the cargo space (16) and a detected height (h1) of the cargo (18).

15. The cargo tracking system (10) according to claim 11, further comprising a conveyor belt (26) for delivering the cargo (18) into the cargo space (16), wherein a distance (d2) of the conveyor belt (26) to the camera (14) is taken into consideration by estimating the size (22) of the cargo (18).

16. The cargo tracking system (10) according to claim 11, wherein a characterizing parameter (30) of the cargo (18) is detectable by the camera (14) and the characterizing parameter (30) is taken into consideration by estimating the size (22) of the cargo (18).

17. The cargo tracking system (10) according to claim 16, wherein the characterizing parameter (30) is a tracking number of the cargo (18) and/or a barcode on the cargo (18) and/or a writing on the cargo (18) describing the size (22) of the cargo (18).

18. The cargo tracking system (10) according to claim 11, wherein a speed of a conveyor belt (26) is taken into consideration by the cargo tracking system (10) and depending on the speed a point in time is predetermined when the cargo space (16) reaches its loading capacity.

19. The cargo tracking system (10) according to claim 11, wherein at least the camera (14) comprises a neural network (28) for estimating the size (22) of the cargo (18).

20. A method for tracking a cargo (18) by a cargo tracking system (10), comprising the steps of:
tracking the cargo (18) during a loading of the cargo (18) into a cargo space (16) for delivering the cargo (18) by a camera (14) of the cargo tracking system (10);
transmitting an information (20) about the cargo (18) to a central electronic computing device (12) of the cargo tracking system (10) by the camera (14);
estimating a size (22) of the cargo (18) by the camera (18) in real time;
computing a remaining cargo size of the cargo space (16) by the camera (14) depending on the estimated size (18) of the cargo (18) and depending on a predetermined cargo size (24) of the cargo space (16); and
transmitting the remaining cargo size to the central electronic computing device (12) in real time by the camera (14).
